(19) United States
(12) Patent Application Publication
(10) Pub. No.: US 2012/0028092 A1
(43) Pub. Date: Feb. 2, 2012

(54) AA LITHIUM PRIMARY BATTERY AND AAA LITHIUM PRIMARY BATTERY

(76) Inventors: Jun Nunome, Kyoto (JP); Kato Fumio, Osaka (JP); Fukuhara Yoshiki, Osaka (JP); Tahara Shinichiro, Osaka (JP)

(21) Appl. No.: 13/259,119

(22) PCT Filed: Dec. 17, 2010
(86) PCT No.: PCT/JP2010/007345

§ 371 Date: Sep. 22, 2011

(30) Foreign Application Priority Data
Mar. 30, 2010 (JP) 2010-079247

(51) Int. Cl. H01M 4/00; H01M 4/38; H01M 2/18; H01M 4/58

(52) U.S. Cl. 429/94

(57) ABSTRACT

An AA lithium primary battery includes: an electrode group 4 including a positive electrode 1 containing iron sulfide as a positive electrode active material, and a negative electrode 2 containing lithium as a negative electrode active material which are wound with a separator 3 interposed therebetween. Part of the negative electrode 2 facing the positive electrode 1 has a mass of 0.86-1.1 g, a total volume of pores in the separator 3 having a pore size of 0.1-10 μm is 0.25 ml/g or lower, and a Gurley number of the separator 3 is 100-1000 sec/100 ml.

### TECHNICAL FIELD

The present invention relates to lithium primary batteries using iron sulfide as a positive electrode active material.

### BACKGROUND ART

Lithium primary batteries using iron sulfide as a positive electrode active material (hereinafter merely referred to as “lithium primary batteries”) are highly practical because they have an average discharge voltage of around 1.5 V, and are compatible with other 1.5 V class primary batteries, e.g., manganese batteries, alkaline manganese batteries etc. A theoretical capacity of iron sulfide as the positive electrode active material is as high as about 894 mAh/g, and a theoretical capacity of lithium as a negative electrode active material is as high as about 3863 mAh/g. Thus, the lithium primary batteries are highly practical as high-capacity, lightweight primary batteries.

An actually used cylindrical lithium primary battery includes an electrode group including a positive electrode and a negative electrode wound with a separator interposed therebetween, and a hollow cylindrical battery case containing the electrode group. Thus, the lithium primary battery has a larger area in which the positive and negative electrodes face each other, and greater discharge characteristic under high load as compared with the other 1.5 V class primary batteries.

When the positive electrode is located at an outermost periphery of the electrode group including the positive and negative electrodes wound with the separator interposed therebetween, impurities eluted from iron sulfide as the positive electrode active material may cause a short circuit between the outermost positive electrode and the battery case which also functions as a negative electrode terminal. For this reason, the negative electrode is generally located at the outermost periphery of the electrode group.

However, when the negative electrode formed with lithium foil is located at the outermost periphery of the electrode group, only an inner side of the outermost negative electrode faces the positive electrode, and an outer side of the outermost negative electrode does not face the positive electrode. Thus, lithium as the negative electrode active material cannot sufficiently be reacted. This is one of obstacles to increase in capacity of the lithium primary battery.

The capacity of the lithium primary battery can be increased when the positive electrode is located at the outermost periphery of the electrode group, and almost all the negative electrode formed with the lithium foil is arranged inside the electrode group.

However, in the lithium primary battery, iron sulfide as the positive electrode active material expands in discharging the battery. The expanded positive electrode presses the separator in discharging the battery to break the separator, thereby causing an internal short circuit between the positive and negative electrodes. From the positive electrode containing iron sulfide as the positive electrode active material, iron ions in iron sulfide are easily eluted in an electrolytic solution, and deposited on the negative electrode. When iron which is dendritically deposited on the surface of the negative electrode grows to penetrate the separator, the internal short circuit may occur between the positive and negative electrodes. In a high capacity lithium primary battery, the internal short circuit increases a short circuit current, thereby accelerating heat generation, and affecting safety of the lithium primary battery.

Patent Document 1 describes a technology of limiting a maximum effective pore size of the separator to 0.08-0.40 μm to obtain high output while maintaining mechanical strength.

Patent Document 2 describes a technology of limiting an average pore size of the separator to 0.01-1 82 m to reduce increase in internal resistance, and stacking two or more separators to increase strength of the separator, thereby reducing the occurrence of the internal short circuit.

Patent Document 3 describes a technology of using a separator having a pore size of 0.005-5 μm, a porosity of 30-70%, a resistance of 2-15 Ωcm², and a tortuosity of 2.5 or lower to improve high rate performance of the lithium primary battery.

### CITATION LIST

### Patent Document

[Patent Document 1] Japanese Translation of PCT International Application No. 2007-513474

[Patent Document 2] Japanese Patent Publication No. S63-72063

[Patent Document 3] U.S. Pat. No. 5,290,414

### SUMMARY OF THE INVENTION

### Technical Problem

According to Patent Documents 1-3, the pore size of the separator is limited to a predetermined range to improve the strength of the separator while maintaining ion permeability of the separator. Patent Documents 1-3 have not considered the internal short circuit caused by the dendritically deposited impurities, such as iron ions eluted from iron sulfide etc.

The present invention is concerned with providing a lithium primary battery having high capacity with high safety while reducing the occurrence of the internal short circuit, and maintaining discharge performance.

### Solution to the Problem

In the present invention, a separator having a pore size distribution in which pores having a pore size of 0.1 μm or larger are preferentially reduced is used in the high capacity lithium primary battery. Thus, the occurrence of the internal short circuit due to the dendritic deposit of iron etc. eluted from iron sulfide is reduced while maintaining the discharge performance.

Specifically, an AA lithium primary battery of the present invention includes: an electrode group including a positive electrode containing iron sulfide as a positive electrode active material, and a negative electrode containing lithium as a negative electrode active material which are wound with a separator interposed therebetween, wherein part of the negative electrode facing the positive electrode has a mass of 0.86-1.1 g, a total volume of pores in the separator having a pore size of 0.1-10 μm is 0.25 ml/g or lower, and a Gurley number of the separator is 100-1000 sec/100 ml.

### ADVANTAGES OF THE INVENTION

According to the present invention, a lithium primary battery having high capacity can be provided with high safety while reducing the occurrence of the internal short circuit, and maintaining the discharge performance.

### BRIEF DESCRIPTION OF THE DRAWINGS

FIG. 1 is a half cross-sectional view illustrating a structure of a lithium primary battery according to an embodiment of the present invention.

FIG. 2 is a table indicating an occurrence rate of a short circuit, an occurrence rate of a short circuit when impurities were increased, and a discharge capacity of AA lithium primary batteries using separators having different total volumes of 0.1-10 μm-sized pores.

FIG. 3 is a table indicating an occurrence rate of a short circuit, an occurrence rate of a short circuit when impurities were increased, and a discharge capacity of AA lithium primary batteries using separators having different total volumes of 1-10 μm-sized pores.

FIG. 4 is a table indicating an occurrence rate of a short circuit, and a discharge capacity of AA lithium primary batteries using separators having different Gurley numbers.

FIG. 5 is a table indicating an occurrence rate of a short circuit, and a discharge capacity of AA lithium primary batteries using negative electrodes containing different amounts of lithium in part thereof facing the positive electrode.

FIG. 6 is a table indicating an occurrence rate of a short circuit, an occurrence rate of a short circuit when impurities were increased, and a discharge capacity of AAA lithium primary batteries using separators having different total volumes of 0.1-10 μm-sized pores.

FIG. 7 is a table indicating an occurrence rate of a short circuit, an occurrence rate of a short circuit when impurities were increased, and a discharge capacity of AAA lithium primary batteries using separators having different total volumes of 1-10 μm-sized pores.

FIG. 8 is a table indicating an occurrence rate of a short circuit, and a discharge capacity of AAA lithium primary batteries using separators having different Gurley numbers.

FIG. 9 is a table indicating an occurrence rate of a short circuit, and a discharge capacity of AAA lithium primary batteries using negative electrodes containing different amounts of lithium in part thereof facing the positive electrode.

### DESCRIPTION OF EMBODIMENTS

An embodiment of the present invention will be described in detail with reference to the drawings. The following embodiment does not limit the present invention. The embodiment may be modified unless otherwise deviated from the scope of the present invention. The embodiment may be combined with other embodiments.

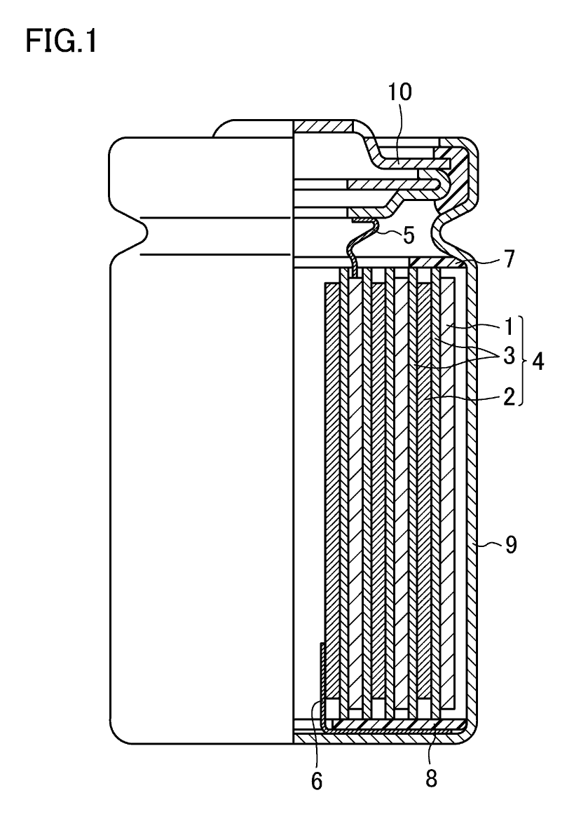

FIG. 1 is a half cross-sectional view illustrating a structure of a lithium primary battery according to an embodiment of the present invention.

As shown in FIG. 1, the lithium primary battery of the present embodiment includes an electrode group 4 including a positive electrode 1 containing iron sulfide as a positive electrode active material, and a negative electrode 2 containing lithium as a negative electrode active material which are wound with a separator 3 interposed therebetween, and a battery case 9 containing the electrode group 4 and a nonaqueous electrolytic solution (not shown). An opening of the battery case 9 is sealed with a sealing plate 10 which also functions as a positive electrode terminal. The positive electrode 1 is connected to the sealing plate 10 through a positive electrode lead 5, and the negative electrode 2 is connected to a bottom surface of the battery case 9 through a negative electrode lead 6. Insulators 7, 8 are arranged at upper and lower ends of the electrode group 4, respectively.

The positive electrode 1 includes a positive electrode current collector (e.g., aluminum etc), and a positive electrode mixture supported on the current collector. The positive electrode mixture contains a positive electrode active material containing iron sulfide as a main ingredient, a binder, a conductive agent, etc. The negative electrode 2 is formed with foil made of lithium (including lithium alloys).

As described above, when the positive electrode containing iron sulfide as the positive electrode active material is used, iron ions are eluted from iron sulfide to the electrolytic solution, and are easily deposited on the negative electrode in the shape of dendrite extending toward the positive electrode. When the dendrite grows and penetrates the separator, an internal short circuit may occur between the positive and negative electrodes. In particular, when such an internal short circuit occurs in a high capacity lithium primary battery, a short circuit current increases, and heat generation is accelerated. This may affect safety of the lithium primary battery.

The separator 3 which electrically insulates the positive electrode 1 and the negative electrode 2 is formed with a microporous film having multiple pores. A porosity and a pore size of the separator 3 are important parameters which influence mechanical strength and discharge performance. In particular, a Gurley number (permeability) is often used as a parameter which generally indicates the porosity and the pore size of the separator 3.

The inventors of the present invention have paid attention to a cause of the internal short circuit, i.e., the iron ions eluted from iron sulfide of the positive electrode are dendritically deposited on the negative electrode, and the dendritic deposit grows to penetrate the separator.

The separator 3 has a certain pore size distribution. It is presumed that the iron ions eluted from the positive electrode preferentially move to pores having a large pore size than to pores having a small pore size. Thus, the inventors have assumed that the occurrence of the internal short circuit due to the growth of the dendritic deposit can be reduced while maintaining the discharge performance when the pore size distribution of the separator is controlled to preferentially reduce the large pores while maintaining the Gurley number of the separator.

To confirm the assumption, the inventors of the present invention have fabricated lithium primary batteries using separators 3 having the same Gurley number, and different ratios of the large pores in the pore size distribution, and have studied the relationship between the ratio of the large pores and the occurrence of the internal short circuit.

Specifically, a total volume of the pores having a pore size of 0.1-10 μm was obtained as the ratio of the large pores. Then, AA lithium primary batteries as shown in FIG. 1 were fabricated using separators having the total volumes of the pores varied in the range of 0.35-0.10 ml/g to obtain a rate of occurrence of the internal short circuit, and a discharge capacity of each battery. The lithium primary batteries were fabricated in the following manner.

The positive electrode 1 was formed in the following manner. A positive electrode mixture prepared by mixing iron sulfide, a conductive agent (Ketchen black), and a binder (polytetrafluoroethylene: PTFE) in a ratio of 94.0:3.5:2.5 [% by mass] was applied to a positive electrode current collector (expanded metal made of stainless steel). The applied mixture was dried, and the dried product was rolled into a size of 44 mm in width, 165 mm in length, and 0.281 mm in thickness.

The obtained positive electrode 1, and a lithium alloy negative electrode 2 formed with lithium metal foil containing lithium metal as a main ingredient, and 500 ppm of tin were wound with a 25 μm thick microporous polyethylene film as a separator 3 interposed therebetween to form an electrode group having an outer diameter of 13.1 mm. The obtained electrode group was placed in the battery case 9 together with a nonaqueous electrolytic solution which is a mixed solvent of propylene carbonate, dioxolane, and dimethoxyethane (volume ratio of 1:60:39) containing lithium iodide as an electrolyte. Thus, an AA lithium primary battery was fabricated.

A thickness of the lithium metal foil was controlled in such a manner that a ratio between theoretical capacities of the positive and negative electrodes facing each other (the theoretical capacity of the negative electrode/the theoretical capacity of positive electrode) per unit area was 0.80. A theoretical capacity of iron sulfide as the positive electrode active material was set to 894 mAh/g.

A Gurley number of the separator 3 was kept to 500 sec/100 ml, and a total volume of the pores in the separator having a pore size of 0.1-10 μm was measured by a mercury intrusion porosimeter (AUTOPORE III9410 of Shimadzu Corporation). Specifically, 10 pieces, each of which is 3 cm×2 cm in size, were cut from the separator 3, and placed in a measurement cell. The Gurley number was measured by digital Oken air permeability tester EG01-6S of Asahi Seiko Co., Ltd.

The rate of the occurrence of the internal short circuit was obtained in the following manner. First, in assembling the battery, electrical resistance between the positive electrode lead 5 and the battery case 9 connected to the negative electrode 2 was measured 10 minutes after the electrolytic solution was injected into the battery case 9 containing the electrode group 4. When the measured electrical resistance was 10 mΩ or lower, it was determined that an internal short circuit was caused by burrs of the positive electrode current collector, and such measurement was removed from consideration. The internal short circuit due to the dendritic growth of the iron ions eluted from the positive electrode is presumed as a minor short circuit, and reduction in electrical resistance due to the minor short circuit is presumably not lower than 10 mΩ.

The fabricated batteries, 20 pieces each, were previously discharged by 3% of theoretical discharge capacity, left for 2 days at 40° C., and returned to 20° C. to measure internal resistance and open circuit voltage of each battery. When the internal resistance was 100 mΩ or lower, or the open circuit voltage was 1.65 V or lower, it was determined that the minor short circuit due to the dendritic deposit of the iron ions eluted from the positive electrode occurred, and the rate of the occurrence (an occurrence rate of the short circuit) was obtained. The internal resistance was measured by an AC four-terminal method using an AC m-ohm Tester (MODEL 3566 of Tsuruga Electric Corporation). As a test for accelerating the dendritic deposition of the iron ions eluted from the positive electrode, 7% by mass of water was added to iron sulfide powder, and the obtained product was left stand for 24 hours at 60° C. to obtain iron sulfide in which an amount of iron sulfate generated by reaction between the iron sulfide powder and water was intentionally increased. Then, using iron sulfide obtained in this way, the lithium primary batteries were fabricated in the same manner as described above. The rate of the occurrence of the internal short circuit of each battery fabricated in this manner (an occurrence rate of the short circuit when impurities were increased) was measured in the same manner as described above.

Each of the batteries was discharged in an atmosphere of 20° C. at a constant current of 100 mA, and a discharge capacity (mAh) until the closed circuit voltage reached 0.9 V was measured.

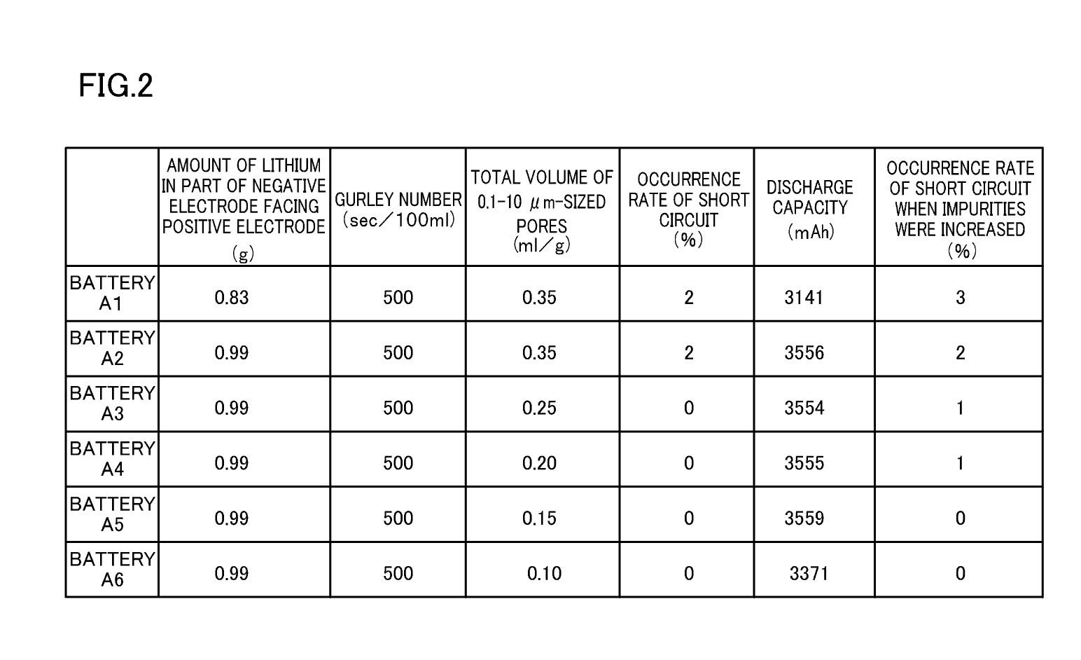

FIG. 2 is a table indicating the occurrence rate of the short circuit, the occurrence rate of the short circuit when impurities were increased, and the discharge capacity of each of lithium primary batteries A1-A6 fabricated using the separators 3 having total volumes of the 0.1-10 μm-sized pores varied in the range of 0.35-0.10 ml/g. In each of Batteries A2-A6, a mass of lithium (an amount of lithium) in part of the negative electrode 2 facing the positive electrode 1 was 0.99 g, i.e., Batteries A2-A6 had higher capacity than Battery A1 in which the amount of lithium was 0.83 g.

As shown in FIG. 2, Batteries A1 and A2 in which the total volume of the 0.1-10 μm-sized pores was 0.35 ml/g experienced the internal short circuit. On the other hand, Batteries A3-A6 in which the total volume of the 0.1-10 μm-sized pores was 0.25 ml/g or lower did not experience the internal short circuit. Batteries A5-A6 in which the total volume of the 0.1-10 μm-sized pores was 0.15 ml/g or lower did not experience the internal short circuit even when the impurities increased. This is presumably because the occurrence of the internal short circuit due to the dendritic iron deposit was reduced by preferentially reducing the large pores in the separator 3.

Even when the large pores in the separator 3 were reduced, Batteries A2-A5 maintained the high discharge capacity as compared with Battery A1 by keeping the Gurley number constant (500 sec/100 ml). Battery A6 in which the total volume of the 0.1-10 μm-sized pores was 0.10 ml/g was slightly reduced in discharge capacity as compared with Batteries A2-A5. In the separator of Battery 6, the total volume of the 0.1-10 μm-sized pores was reduced, and the Gurley number was kept to 500 sec/100 ml. Therefore, the number of the small pores was reduced in the pore size distribution, thereby inhibiting movement of ions in the electrolytic solution.

The results indicate that the occurrence of the internal short circuit due to the dendritic iron deposit can effectively be reduced by controlling the total volume of the 0.1-10 μm-sized pores in the separator 3 to 0.25 ml/g or lower, more preferably 0.15 ml/g or lower. When the total volume of the 0.1-10 μm-sized pores in the separator 3 is set higher than 0.10 ml/g, the movement of the ions in the electrolytic solution is not inhibited, and the discharge performance is not reduced.

Further, to confirm the effect of reducing the occurrence of the internal short circuit due to the dendritic iron deposit by preferentially reducing the large pores, Batteries B1-B4 having the same total volume of the 0.1-10 μm-sized pores (0.20 ml/g), and different total volumes of 1-10 μm-sized pores varied in the range of 0.10-0.05 ml/g were fabricated to obtain the occurrence rate of the internal short circuit.

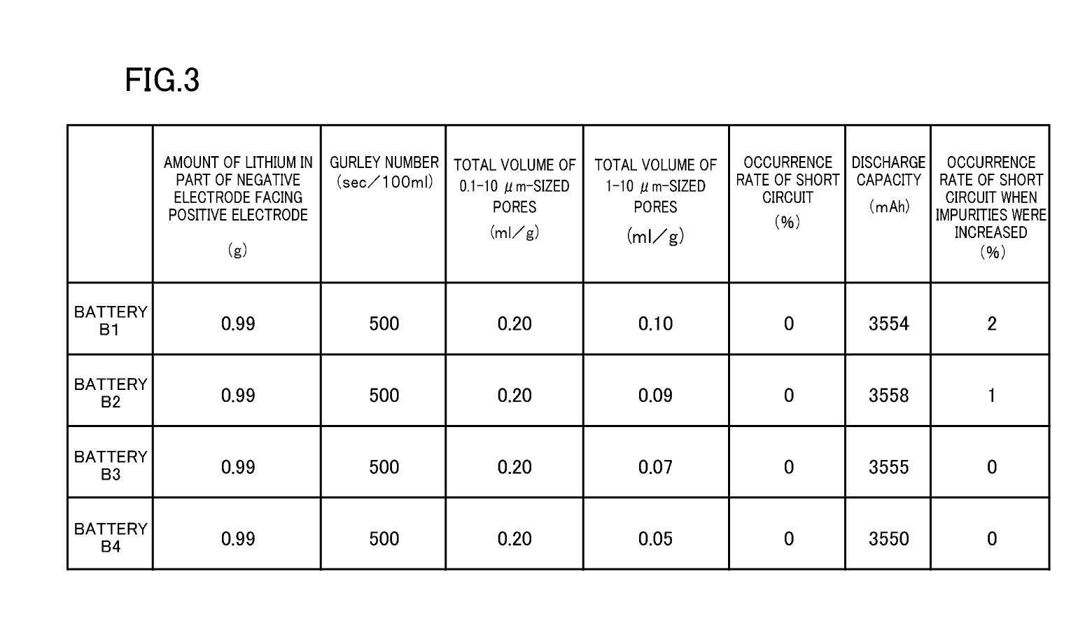

FIG. 3 shows a table indicating the results. Batteries B3-B4 in which the total volume of the 1-10 μm-sized pores was 0.07 ml/g or lower did not experience the internal short circuit even when the impurities increased. This indicates that the occurrence of the internal short circuit due to the dendritic iron deposit can effectively be reduced by controlling the total volume of the 1-10 μm-sized pores in the separator to 0.07 ml/g or lower.

Thus, even when the large pores of the separator 3 are preferentially reduced, the internal short circuit due to the dendritic iron deposit can effectively be reduced while maintaining the discharge performance by keeping the Gurley number constant. However, when the Gurley number is too low, the large pores cannot be easily reduced, and the advantage of the present invention may not sufficiently be provided. When the Gurley number is too high, ion permeability of the separator 3 is insufficient, and the discharge performance may not sufficiently be maintained.

To check a suitable range of the Gurley number which is advantageous to the present invention, Batteries C1-05 having the same total volume of the 0.1-10 μm-sized pores (0.20 ml/g), and different Gurley numbers varied in the range of 60-2000 sec/100 ml were fabricated, and the occurrence rate of the short circuit and the discharge capacity of each battery were measured.

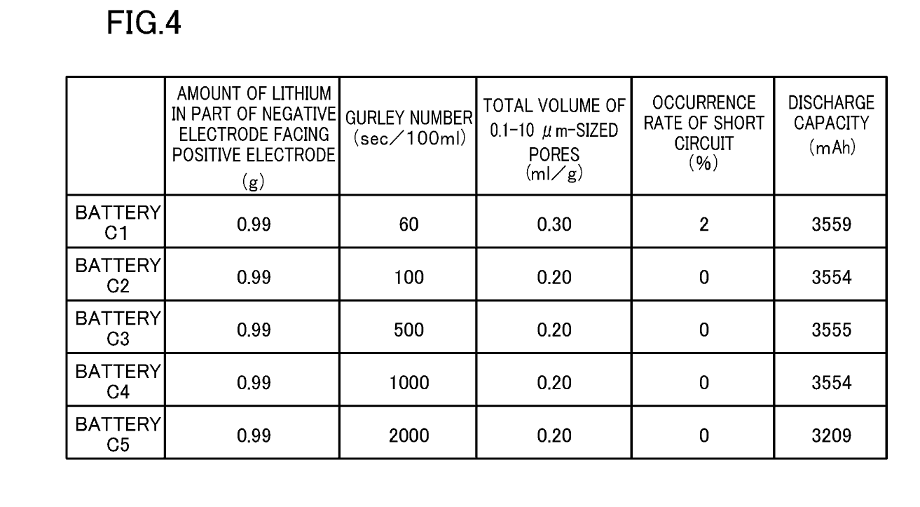

FIG. 4 is a table indicating the measurement results. Batteries C2-C4 in which the Gurley number was 100-1000 sec/100 ml did not experience both of the internal short circuit and reduction in discharge capacity. However, the internal short circuit occurred in Battery Cl in which the Gurley number was 60 sec/100 ml. This indicates that the total volume of the 0.1-10 μm-sized pores cannot be reduced to 0.30 ml/g or lower when the

Gurley number is too low. Thus, it is presumed that the internal short circuit due to the dendritic iron deposit cannot sufficiently be reduced in the presence of the large pores. Battery C5 in which the Gurley number was 2000 sec/100 ml was reduced in discharge capacity. This indicates that the ion permeability of the separator 3 is insufficient when the Gurley number is too high, and sufficient discharge capacity cannot be maintained. Thus, the separator 3 preferably has the Gurley number of 100-1000 sec/100 ml.

The results indicates that the occurrence of the internal short circuit due to the dendritic iron deposit can be reduced while maintaining the discharge performance by controlling the total volume of the 0.1-10 μm-sized pores in the separator 3 to 0.25 ml/g or lower, and controlling the Gurley number of the separator 3 to 100-1000 sec/100 ml. Thus, even when the capacity of the lithium primary battery is increased, the lithium primary battery can be provided with high safety, while reducing the occurrence of the internal short circuit.

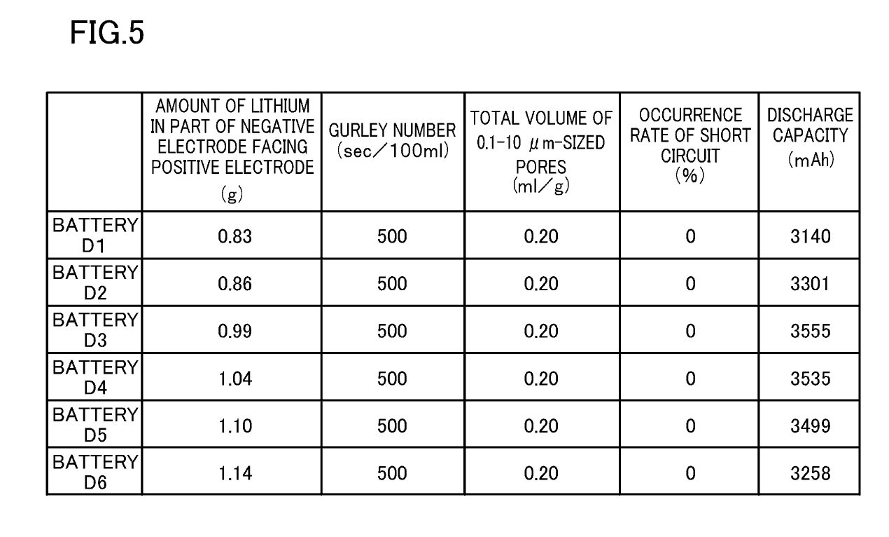

FIG. 5 is a table indicating the occurrence rate of the short circuit, and the discharge capacity of Batteries D1-D6 having the same Gurley number, the same total volume of the 0.1-10 μm-sized pores, and different amounts of lithium in part of the negative electrode facing the positive electrode varied in a range of 0.83-1.14 g.

As shown in FIG. 5, Batteries D2-D5 having high capacity in which the amount of lithium in the part of the negative electrode facing the positive electrode was 0.86-1.10 g did not experience the internal short circuit, and reduction in discharge capacity. However, Battery D6 in which the amount of lithium in the part of the negative electrode facing the positive electrode was 1.14 g was reduced in discharge capacity, although the internal short circuit did not occur. This is because the size of the battery case 9 was limited, and the amount of the positive electrode was relatively reduced due to excessive increase in amount of lithium.

As described above, in the AA lithium primary battery of the present invention, the mass of the part of the negative electrode 2 facing the positive electrode 1 is preferably 0.86-1.1 g, the total volume of the 0.1-10 μm-sized pores in the separator 3 is preferably 0.25 ml/g or lower, and the Gurley number of the separator 3 is preferably 100-1000 sec/100 ml. Thus, even when the capacity of the lithium primary battery is increased, the lithium primary battery can be provided with high safety while reducing the occurrence of the internal short circuit due to the growth of the dendritic deposit, and maintaining the discharge performance.

The total volume of the 0.1-10 μm-sized pores in the separator 3 is preferably 0.15 ml/g or lower. Thus, even when an unexpectedly large amount of impurities is contained in iron sulfide, the occurrence of the internal short circuit due to the dendritic iron deposit can effectively be reduced.

The total volume of the 0.1-10 μm-sized pores in the separator 3 is preferably higher than 0.10 ml/g. Thus, the movement of ions in the electrolytic solution is not inhibited, and the discharge performance is not reduced.

The total volume of the 1-10 μm-sized pores in the separator 3 is preferably 0.07 ml/g or lower. This can reduce the occurrence of the internal short circuit due to the dendritic iron deposit more effectively.

The structure of the electrode group according to the present invention is not particularly limited. However, to fabricate the high capacity lithium primary battery in which the mass of the part of the negative electrode 2 facing the positive electrode 1 is 0.86-1.1 g, the electrode group 4 which is wound in such a manner that the positive electrode is located at the outermost periphery as shown in FIG. 1 is preferably used.

The material of the separator of the present invention is not particularly limited. For example, a microporous film made of polyethylene, polypropylene, etc., may be used. The separator having a predetermined particle size distribution of the present invention can be fabricated by, for example, the following method. However, the method for fabricating the separator is not limited thereto.

High density polyethylene and low density polyethylene as material resins, and dioctyl phthalate as a pore-forming material were mixed, and the mixture was granulated to form resin granules. The obtained resin granules were molten and kneaded at 220° C. in an extruder provided with a T-die at a tip end thereof, and the molten resin was extruded. An extruded sheet was rolled using rollers heated to about 120° C. to form a 100 μm thick sheet. The obtained sheet was immersed in methyl ethyl ketone to extract and remove dioctyl phthalate. The sheet was then uniaxially drawn in an environment of 124° C. until a width of the sheet was multiplied by about 3.5. Thus, the separator of a final thickness is obtained.

In the above description, the AA lithium primary battery has been described as an example of the high capacity lithium primary battery of the present invention. However, also in AAA lithium primary batteries, the present invention can advantageously reduce the occurrence of the internal short circuit due to the dendritic iron deposit while maintaining the discharge capacity by preferentially reducing the large pores in the separator 3.

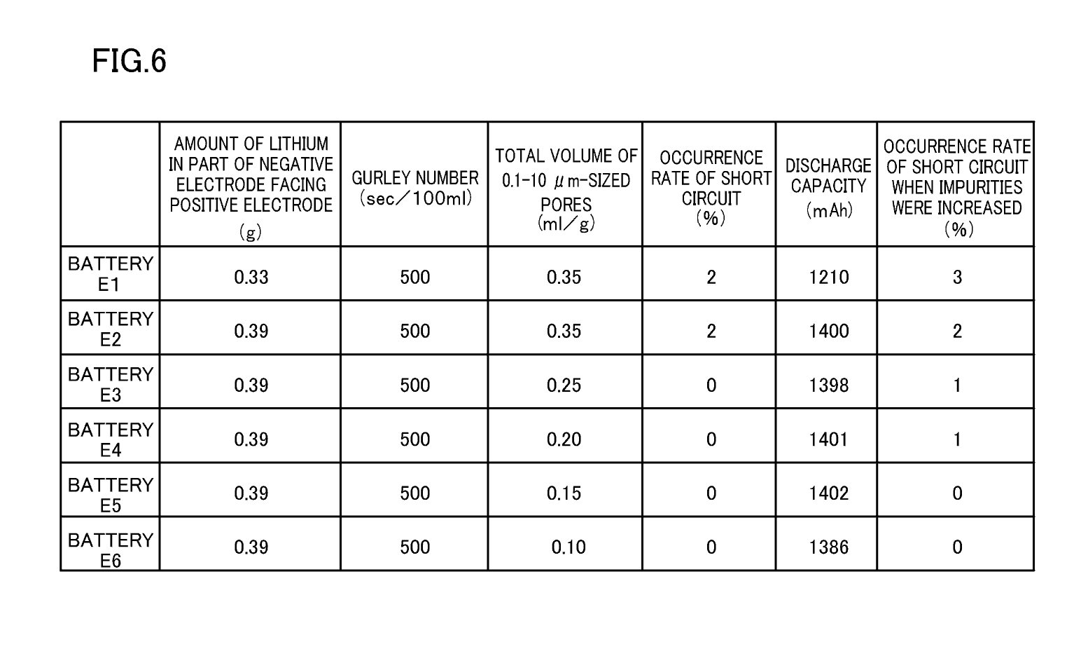

Like FIG. 2, FIG. 6 shows a table indicating the occurrence rate of the short circuit, the occurrence rate of the short circuit when impurities were increased, and the discharge capacity of AAA lithium primary batteries E1-E6 having different total volumes of the 0.1-10 μm-sized pores in the separator 3 varied in the range of 0.35-0.10 ml/g. In Batteries E2-E6, the amount of lithium in the part of the negative electrode facing the positive electrode was 0.39 g, i.e., Batteries E2-E6 had higher capacity than Battery E1 in which the amount of lithium was 0.33 g.

As shown in FIG. 6, Batteries E1, E2 in which the total volume of the 0.1-10 μm-sized pores was 0.35 ml/g experienced the internal short circuit, while Batteries E3-E6 in which the total volume of the 0.1-10 μm-sized pores was 0.25 ml/g or lower did not experience the internal short circuit. In Batteries E5-E6 in which the total volume of the 0.1-10 μm-sized pores was 0.15 ml/g or lower, the internal short circuit did not occur even when the impurities increased. As compared with Battery E1, Batteries E2-E5 maintained the increased discharge capacity by keeping the Gurley number constant (500 sec/100 ml) even when the large pores in the separator 3 were reduced. Battery E6 in which the total volume of the 0.1-10 μm-sized pores was 0.10 ml/g was reduced in discharge capacity as compared with Batteries E2-E5. The results were the same as the results of the AA lithium primary batteries shown in FIG. 2.

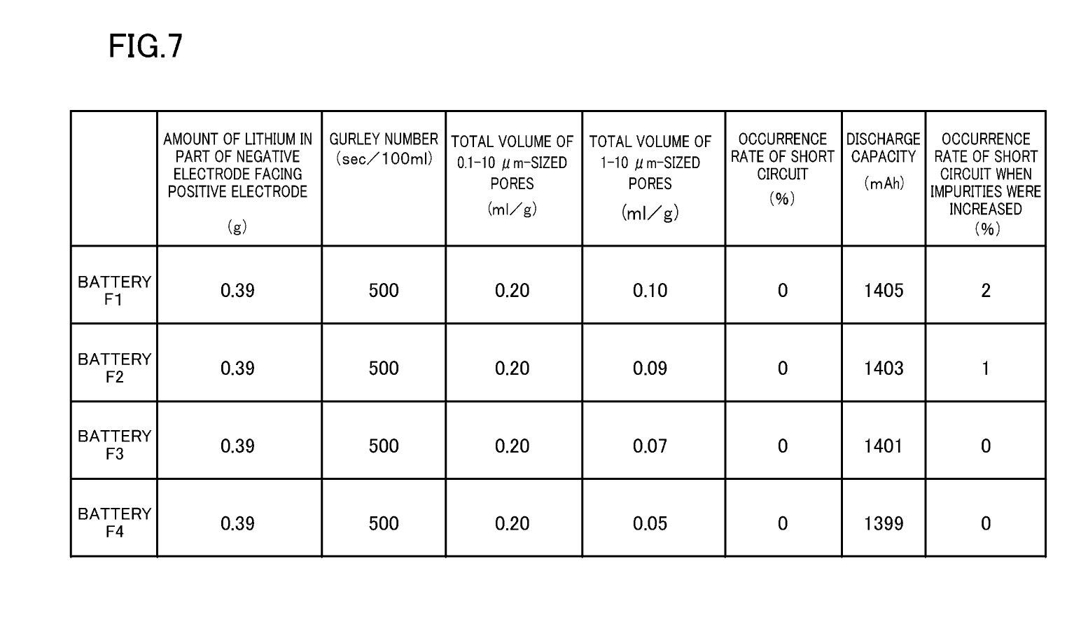

Like FIG. 3, FIG. 7 shows a table indicating the occurrence rate of the short circuit, the occurrence rate of the short circuit when impurities were increased, and the discharge capacity of AAA lithium primary batteries F1-F4 having the same total volume of the 0.1-10 μm-sized pores was kept constant (0.20 ml/g), and different total volumes of 1-10 μm-sized pores varied in the range of 0.10-0.05 ml/g. As shown in FIG. 7, Batteries F3-F4 in which the total volume of 1-10 μm-sized pores was 0.07 ml/g or lower did not experience the internal short circuit even when the impurities were increased. The results were the same as the results of the AA lithium primary batteries shown in FIG. 3.

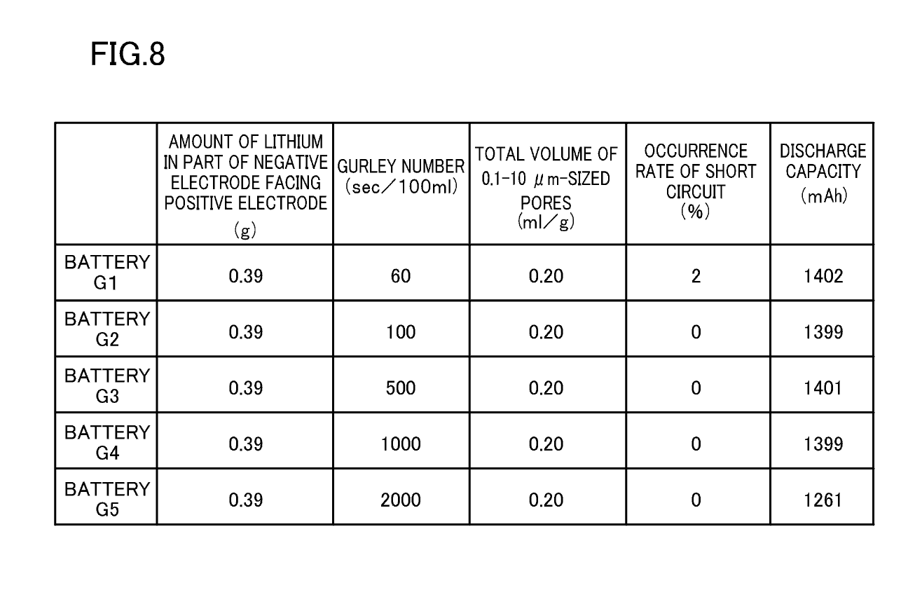

Like FIG. 4, FIG. 8 shows a table indicating the occurrence rate of the internal short circuit, and the discharge capacity of AAA lithium primary batteries G1-G5 having the same total volume of the 0.1-10 μm-sized pores (0.20 ml/g), and different Gurley numbers varied in the range of 60-2000 sec/100 ml.

As shown in FIG. 8, Batteries G2-G4 in which the Gurley number was 100-1000 sec/100 ml did not experience the internal short circuit, and reduction in discharge capacity, while Battery G1 in which the Gurley number was 60 sec/100 ml experienced the internal short circuit. In Battery G5 having the Gurley number of 2000 sec/100 ml, the discharge capacity was reduced. The results were the same as the results of the AA lithium primary batteries shown in FIG. 4.

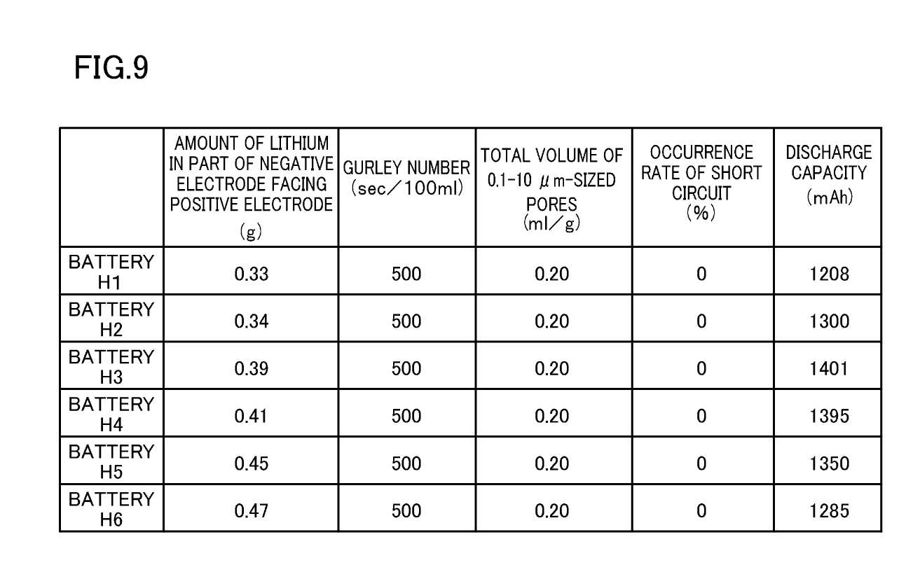

Like FIG. 5, FIG. 9 shows a table indicating the occurrence rate of the short circuit, and the discharge capacity of AAA lithium primary batteries H1-H6 having the same Gurley number, the same total volume of the 0.1-10 μm-sized pores, and different amounts of lithium in the part of the negative electrode facing the positive electrode varied in the range of 0.33-0.47 g.

As shown in FIG. 9, Batteries H2-H5 having high capacity in which the amount of lithium in the part of the negative electrode facing the positive electrode was 0.34-0.47 g did not experience the internal short circuit, and reduction in discharge capacity. However, in Battery H6 in which the amount of lithium in the part of the negative electrode facing the positive electrode was 0.47 g, the discharge capacity was reduced, although the internal short circuit did not occur. The results were the same as the results of the AA lithium primary batteries shown in FIG. 5.

Thus, when the total volume of the 0.1-10 μm-sized pores in the separator 3 is controlled to 0.25 ml/g or lower, and the Gurley number of the separator 3 is controlled to 100-1000 sec/100 ml in the AAA lithium primary battery having increased capacity (a mass of the part of the negative electrode 2 facing the positive electrode 1 is 0.34-0.45 g), the occurrence of the internal short circuit due to the dendritic iron deposit can be reduced while maintaining the discharge performance. This can provide the lithium primary battery with high safety.

The present invention has been described by way of the preferred embodiment. The present invention is not limited to the description, and can be modified in various ways. For example, in the present embodiment, a lithium alloy containing 500 ppm of tin is used as the negative electrode. However, the negative electrode may be made of an alloy containing lithium as a main ingredient, and other metals. Adding a small amount of tin to the negative electrode is presumably effective for improving the discharge performance, and for preventing adverse effect of impurities which are eluted from the positive electrode and deposited on the negative electrode.

### INDUSTRIAL APPLICABILITY

The present invention is useful for 1.5 V class primary batteries which are compatible with alkaline dry batteries etc.

### DESCRIPTION OF REFERENCE CHARACTERS

1 Positive electrode

2 Negative electrode

3 Separator

4 Electrode group

5 Positive electrode lead

6 Negative electrode lead

7, 8 Insulator

9 Battery case

10 Sealing plate

1. An AA lithium primary battery comprising:
an electrode group including a positive electrode containing iron sulfide as a positive electrode active material, and a negative electrode containing lithium as a negative electrode active material which are wound with a separator interposed therebetween, wherein
part of the negative electrode facing the positive electrode has a mass of 0.86-1.1 g, a total volume of pores in the separator having a pore size of 0.1-10 μm is 0.25 ml/g or lower, and
a Gurley number of the separator is 100-1000 sec/100 ml.

2. The AA lithium primary battery of claim 1, wherein
the total volume of the pores in the separator having the pore size of 0.1-10 μm is 0.15 ml/g or lower.

3. The AA lithium primary battery of claim 1, wherein
the total volume of the pores in the separator having the pore size of 0.1-10 μm is higher than 0.10 ml/g.

4. The AA lithium primary battery of claim 1, wherein
the total volume of the pores in the separator having the pore size of 1-10 μm is 0.07 ml/g or lower.

5. The AA lithium primary battery of claim 1, wherein
the positive electrode is located at an outermost periphery of the electrode group.

6. An AAA lithium primary battery comprising:
an electrode group including a negative electrode containing lithium as a negative electrode active material, and a positive electrode containing iron sulfide as a positive electrode active material which are wound with a separator interposed therebetween, wherein
part of the negative electrode facing the positive electrode has a mass of 0.34-0.45 g,
a Gurley number of the separator is 100-1000 sec/100 ml, and
a total volume of pores in the separator having a pore size of 0.1-10 μm is 0.25 ml/g or lower.

7. The AAA lithium primary battery of claim 6, wherein
the total volume of the pores in the separator having the pore size of 0.1-10 μm is 0.18 ml/g or lower.

8. The AAA lithium primary battery of claim 6, wherein
the total volume of the pores in the separator having the pore size of 0.1-10 μm is higher than 0.10 ml/g.

9. The AAA lithium primary battery of claim 6, wherein
the total volume of the pores in the separator having the pore size of 0.1-10 μm is 0.07 ml/g or lower.

10. The AAA lithium primary battery of claim 6, wherein
the positive electrode is located at an outermost periphery of the electrode group.
